(19) United States
(12) Patent Application Publication
(10) Pub. No.: US 2003/0221096 A1
(43) Pub. Date: Nov. 27, 2003

(54) Information processing apparatus, information processing method, IC card, program, and record medium

(75) Inventor: Daisuke Wada, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/438,007

(22) Filed: May 15, 2003

(30) Foreign Application Priority Data
May 23, 2002 (JP) JP2002-149368

(51) Int. Cl. G06F 9/00

(52) U.S. Cl. 713/2

(57) ABSTRACT

An objective is to provide an information processing apparatus etc. that can simply restore a BIOS, which was no longer capable of normally activating a system, to a normal BIOS.

An information processing apparatus 100 outputs a command for reading out the BIOS when an electric power source is commissioned. Thereafter, before a BIOSROM 14 initiates the activation, the information processing apparatus 100 reads out an initialization program for initializing a system pre-stored in a BIOSROM card 20 mounted on a PCI slot 15, and initializes the system according to the initialization program. Next, the information processing apparatus 100 reads out a BIOSROM rewrite program stored in the BIOSROM card 20, and files in the BIOSROM 14 a BIOS control code stored in the BIOSROM card 20, according to the write program that was read.

### BACKGROUND OF THE INVENTION

The present invention relates to an information processing apparatus, an information processing method, and a program for restoring a BIOSROM that was no longer capable of normally activating a system.

Conventionally, the information processing apparatus such as a personal computer comprises the BIOSROM for storing a BIOS (Basic Input-Output System) such as activation of an operating system (OS) and basic establishment of hardware required so that the information processing apparatus is normally activated, which is composed of a flash memory.

The BIOSROM is configured of a basic function section for activating the OS (as a matter of fact, for activating a program called an IPL (Initial Program Loader)) and initializing the hardware, which is referred to as a BOOT-BLOCK that is basically not rewritten, and an extensible function section comprising information etc. such as addition/alteration of the hardware, which is referred to as a NON BOOT-BLOCK that is rewritable.

As the case may be, it is necessary to rewrite the BOOT-BLOCK that is basically not rewritten, and if the rewriting fails, the BOOT-BLOCK is destroyed, and the system becomes impossible to commission.

Accordingly, when the rewriting of the BOOT-BLOCK fails, so as to commission the system again, the BIOSROM, which stores the BIOS that failed in rewriting, has to be replaced with the BIOSROM that stores the normal BIOS.

However, replacement of the BIOSROM requires a specialized tool and specialized technology etc., and the problem exited that nobody was able to simply replace the BIOSROM.

Thus, as to the technology associated with restoration of the troubled BIOSROM, such technology as mentioned below is listed.

In JP-P2000-222198A is disclosed the technology for replacing a basic program (for example, the BIOS) based on information of a card inserted into-a card slot. Also, the technology was disclosed in JP-P2001-222421A for updating an operation of the BIOS without rewriting the BIOS. Also, the technology, which made it possible to easily update firmware by utilizing a memory card, was disclosed in JP-P1993-143315A. Furthermore, in JP-P1995-191841A, the technology was disclosed for updating a program of the sub CPU by utilizing an IC card in a system comprising a main CPU and a sub CPU.

However, as to these kinds of the technology mentioned above, at the time that the BIOS filed in the BIOSROM was erroneously written once, and the system came into the situation that it was not activated, no technology for restoring it to the normal BIOS was disclosed.

### DISCLOSURE OF THE INVENTION

In consideration of the foregoing problems, the present invention has an objective of providing an information processing apparatus etc. that can simply restore the BIOS, which was no longer capable of normally activating the system, to the normal BIOS.

Also, the present invention has an objective of providing an information processing apparatus etc. that can simply restore the BIOS, which was no longer capable of normally activating the system, to the normal BIOS without replacing the BIOSROM.

So as to accomplish the above-mentioned objectives, an information processing apparatus relating to a first viewpoint, which is an information processing apparatus for restoring a faulty BIOS, which was stored in a BIOSROM, and was no longer capable of normally activating the system, to a normal BIOS capable of normally activating it, is characterized in comprising: mounting means for mounting an IC card; read-out command output means for, when an electric power source is commissioned, outputting a command for reading out the BIOS from said BIOSROM; initialization means for, before said faulty BIOS is read out from said BIOSROM after said command was output by said read-out command output means, reading out an initialization program for initializing the system from said IC card mounted on said mounting means to initialize the system according to the above initialization program that was read out; and BIOS write means for, after the system was initialized by said initialization means, reading out a write program for writing said normal BIOS stored in said IC card into said BIOSROM from the above IC card to write the above normal BIOS into said BIOSROM according to the above write program that was read out.

Such a configuration allows the BIOS, which was no longer capable of normally activating the system, to be restored to the normal BIOS simply.

That is, the BIOS, which was no longer capable of normally activating the system, can be simply restored to the normal BIOS without replacing the BIOSROM.

Also, an information processing method relating to a second viewpoint of the present invention, which is an information processing method for restoring a faulty BIOS, which was stored in a BIOSROM, and was no longer capable of normally activating a system, to a normal BIOS capable of normally activating it, is characterized in: when an electric power source is commissioned, outputting a command for reading out the BIOS from said BIOSROM; before said faulty BIOS is read out from said BIOSROM after said command was output, reading out an initialization program for initializing the system from a mounted IC card to initialize the system according to the above initialization program that was read out; and after the system was initialized, reading out a write program for writing said normal BIOS stored in said IC card into said BIOSROM from the above IC card to write the above normal BIOS into said BIOSROM according to the above write program that was read out.

Such a configuration allows the BIOS, which was no longer capable of normally activating the system, to be restored to the normal BIOS simply.

That is, the BIOS, which was no longer capable of normally activating the system, can be simply restored to the normal BIOS without replacing the BIOSROM.

Also, an IC card relating to a third viewpoint of the present invention, which is an IC card to be mounted on an information processing apparatus comprising a BIOSROM, is characterized in comprising: an initialization program for initializing a system of the information processing apparatus; a BIOS for activating said system normally; a write program for writing said BIOS into said BIOSROM; initialization program output means for, after an electric power source of said information processing apparatus was commissioned, when a command for reading out the BIOS stored in said BIOSROM is input from the above information processing apparatus, outputting said initialization program to the above information processing apparatus; write program output means for, after said initialization program was output to the above information processing apparatus by said initialization program output means, and the system of the above information processing apparatus was initialized, outputting to said information processing apparatus a write program for writing said BIOS into said BIOSROM; and BIOS output means for, according to said write program output by said write program output means, outputting said BIOS to said information processing apparatus.

Such a configuration allows the BIOS, which was no longer capable of normally activating the system, to be restored to the normal BIOS simply.

That is, the BIOS, which was no longer capable of normally activating the system, can be simply restored to the normal BIOS without replacing the BIOSROM.

Also, a program relating to a fourth viewpoint of the present invention, which is a program for restoring a faulty BIOS, which was stored in a BIOSROM, and was no longer capable of normally activating the system, to a normal BIOS capable of normally activating it, causes a computer to execute the processes of: when an electric power source is commissioned, outputting a command for reading out the BIOS from said BIOSROM; before said faulty BIOS is read out from said BIOSROM after said command was output, reading out an initialization program for initializing the system from an mounted IC card to initialize the system according to the above initialization program that was read out; after the system was initialized, reading out a write program for writing said normal BIOS stored in said IC card program into said BIOSROM from the above IC card to write the above normal BIOS into said BIOSROM according to the above write program that was read out.

Such a configuration allows the BIOS, which was no longer capable of normally activating the system, to be restored to the normal BIOS simply.

That is, the BIOS, which was no longer capable of normally activating the system, can be simply restored to the normal BIOS without replacing the BIOSROM.

### BRIEF DESCRIPTION OF THE DRAWING

This and other objects, features and advantages of the present invention will become more apparent upon a reading of the following detailed description and drawings, in which:

FIG. 1 is a block diagram illustrating a configuration of an information processing apparatus relating to an embodiment of the present invention;

FIG. 2 is a block diagram illustrating a configuration of a BIOSROM card in FIG. 1; and

FIG. 3 is a flowchart illustrating an operation of the information processing apparatus relating to the embodiment.

### DESCRIPTION OF THE EMBODIMENT

The information processing apparatus and the IC card relating to the embodiment of the present invention will be explained.

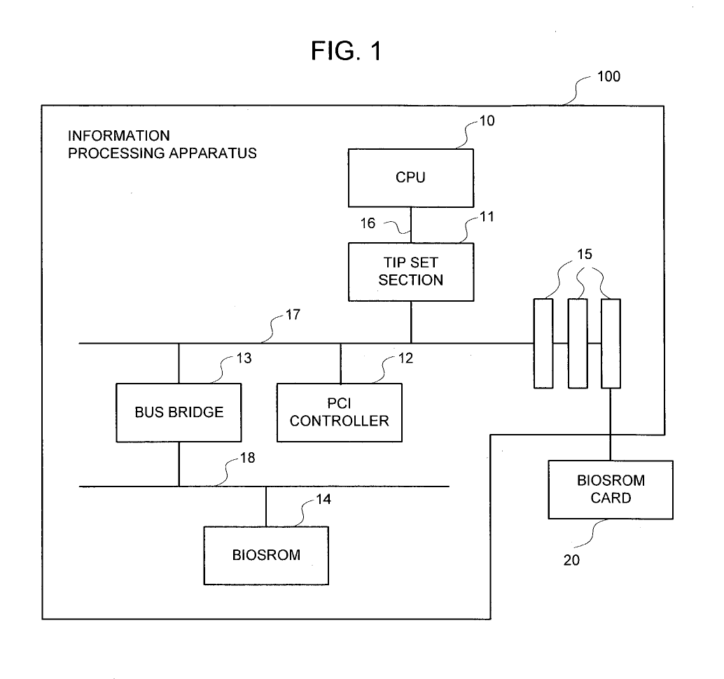

FIG. 1 is a block diagram illustrating the configuration of the information processing apparatus relating to the embodiment of the present invention.

This information processing apparatus 100, which is composed of a personal computer etc., comprises a CPU (Central Processing Unit) 10, a tip set section 11, a PCI (Peripheral Component Interconnect) controller 12, a bus bridge 13, a BIOSROM 14, and a plurality of PCI slots 15.

And, the CPU 10 and the tip set section 11 are connected by a local bus 16, the tip set section 11, the PCI controller 12, the bus bridge 13, and a plurality of the PCI slots 15 are mutually connected by a PCI bus 17, and the bus bridge 13 and the BIOSROM 14 are connected to an ISA (Industry Standard Architecture) bus 18.

The CPU 10 executes a process to be described later according to a control program.

The tip set section 11 controls transfer of data between the local bus 16 and the PCI bus 17 that have different transmission speeds respectively.

The PCI controller 12 controls data supplied to the PCI bus 17.

The bus bridge 13 controls conversion of the bus between the PCI bus 17 and the ISA bus 18.

The BIOSROM 14 is configured of a flash ROM, is mounted on a motherboard as a mounting location, and has a BIOS, which is required in commissioning the system, stored.

A plurality of the PCI slots 15 are an expansion slot for detachably connecting a PCI expansion card responding to necessity. As to the PCI expansion card, there is a BIOSROM card 20 to be explained next.

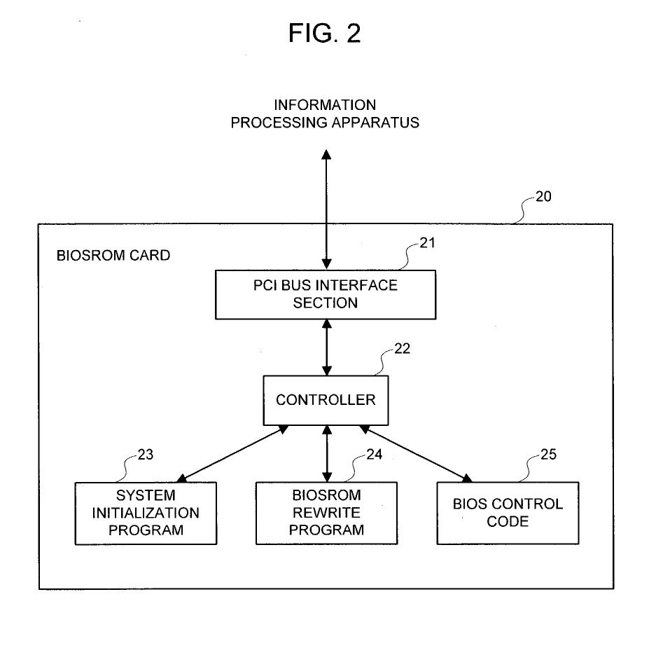

The BIOSROM card 20 shown in FIG. 1 comprises a PCI bus interface section 21, a controller 22, a system initialization program 23, a BIOSROM rewrite program 24, and a BIOS control code 25 as shown in FIG. 2.

The PCI bus interface section 21 inputs/outputs address/data signals of the PCI bus 17 and various control signals into/from the information processing apparatus 100.

The controller 22 executes a process of supplying the system initialization program 23, the BIOSROM rewrite program 24, and the BIOS control code 25 to the information processing apparatus 100.

The system initialization program 23 is a program for initializing a system (for example, clearing a work area to be configured in a memory, establishment of hardware information etc.) that exists in the information processing apparatus 100.

The BIOSROM rewrite program 24 is a program for rewriting the BIOS capable of normally activating the system into the initialized BIOSROM 14. Additionally, it is not always necessary that the BIOSROM rewrite program 24 rewrites all data of the BIOSROM 14, and by comparing the BIOS (the control code of the BIOS) stored in the BIOSROM 14 with the BIOS control code 25, only the part in which each of them differs from the other should be rewritten.

The BIOS control code 25, which is a control code configuring the BIOS capable of normally activating the system of the information processing apparatus 100, is written into the BIOSROM 14.

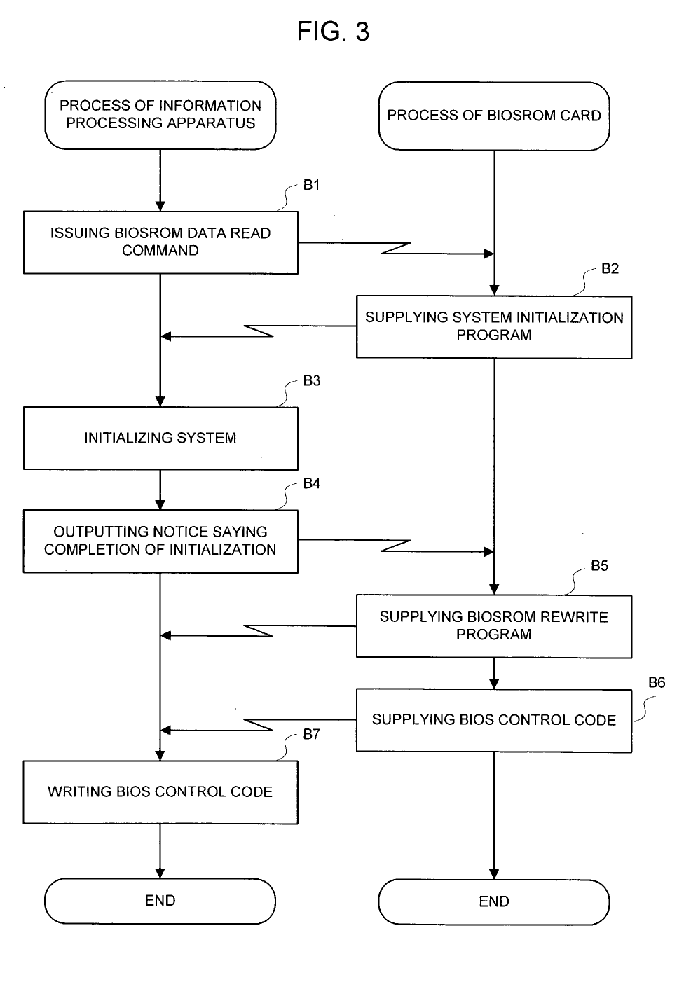

Next, an operation of the information processing apparatus 100 and the BIOSROM card 20 relating to this embodiment will be explained by referring to a flowchart shown in FIG. 3.

At first, the BIOSROM card 20 is inserted into the PCI slot 15 with the electric power source of the information processing apparatus 100 switched off, thereafter, when the electric power source is switched on, so as to read out a BOOT program (IPL program) configuring the BIOS from the BIOSROM 14, the CPU 10 configuring the information processing apparatus 100 issues a BIOSROM data read command (step B1). The BIOSROM data read command is output over the PCI bus 17 via the tip set section 11.

Herein, the above-mentioned BIOSROM data read command is a command to be output to a location of which an address number was shown in ┌FFFFFFFOh┘, and the BIOSROM card 20 comprising this address responds to this command.

When the BIOSROM data read command is input from the CPU 10 of the information processing apparatus 100, the controller 22 configuring the BIOSROM card 20 transmits the system initialization program 23 to the CPU 10 via the PCI bus interface section 21 (step B2).

When the system initialization program 23 is supplied from the BIOSROM card 20, the CPU 10 of the information processing apparatus 100 initializes the system according to the initialization program (step B3).

Next, when the CPU 10 of the information processing apparatus 100 finishes the initialization, it output to the BIOSROM card 20 the notice saying the effect that the initialization was finished (step B4).

When the controller 22 of the BIOSROM card 20 receives from the information processing apparatus 100 the notice saying the effect that the initialization was finished, it outputs the BIOSROM rewrite program to the CPU 10 of the information processing apparatus 100 (step B5).

Thereafter, the BIOSROM card 20 outputs the BIOS control code 25 to the CPU 10 of the information processing apparatus 100 (step B6).

The CPU 10 of the information processing apparatus 100 stores the BIOSROM rewrite program supplied from the BIOSROM card 20 in a RAM, thereafter, according to the stored BIOSROM rewrite program, it writes the BIOS control code 25 read out from the BIOSROM card 20 into the BIOSROM 14, and restores the BIOS, which was not capable of normally activating the system, to the normal BIOS (step B7), and the process is finished.

Thereafter, the electric power source of the information processing apparatus 100 is switched off, and the BIOSROM card 20 is removed from the PCI slot 15. Next time, when the electric power source of the information processing apparatus 100 is switched on, the information processing apparatus 100 is normally activated because BIOS data of the BIOSROM 14 was already rewritten for correct one.

In accordance with the information processing apparatus 100 of this embodiment, after the system was initialized according to the initialization program output from the mounted BIOSROM card 20, the BIOS control code 25 stored in the BIOSROM card 20 is written into the BIOSROM 14, according to the write program for writing the normal BIOS into the BIOSROM 14, whereby the BIOS that was no longer capable of normally activating the system can be restored to the normal BIOS simply.

Accordingly, the BIOSROM 14 can be restored simply without necessity for the specialized tool and the specialized technology etc. for removing the BIOSROM 14 from the information processing apparatus 100 for replacement.

In accordance with the information processing apparatus relating this embodiment, when the initialization program within the PCI card, the BIOSROM rewrite program, and the BIOS control code are rewritten for matching them to the computer system, they are usable in many computer systems.

As explained above, in accordance with the present invention, the BIOS that was no longer capable of normally activating the system can be restored to the normal BIOS simply. Additional advantages and modifications will readily occur to those skilled in the art. Accordingly, it will be understood that the invention is not intended to be limited to the embodiment described in the specification. Various modifications may be made without departing from the spirit or scope of the general inventive concept as defined by the appended claims.

The entire disclosure of Japanese Patent Application No. 2002-149368 filed on May 23, 2002 including specification, claims, drawing and summary are incorporated herein by reference in its entirety.

What is claimed is:

1 An information processing apparatus for restoring a faulty BIOS, which was stored in a BIOSROM, and was no longer capable of normally activating a system, to a normal BIOS capable of activating it normally, said information processing apparatus comprising:
mounting means for mounting an IC card;
read-out command output means for, when an electric power source is commissioned, outputting a command for reading out the BIOS from said BIOSROM;
initialization means for, before said faulty BIOS is read out from said BIOSROM after said command was output by said read-out command output means, reading out an initialization program for initializing the system from said IC card mounted on said mounting means to initialize the system according to the above initialization program that was read out; and
BIOS write means for, after the system was initialized by said initialization means, reading out a write program for writing said normal BIOS stored in said IC card into said BIOSROM from the above IC card to write the above normal BIOS into said BIOSROM according to the above write program that was read out.

2 An information processing method of restoring a faulty BIOS, which was stored in a BIOSROM, and was no longer capable of normally activating a system, to a normal BIOS capable of activating it normally, said information processing method comprising the steps of:
when an electric power source is commissioned, outputting a command for reading out the BIOS from said BIOSROM;
before said faulty BIOS is read out from said BIOSROM after said command was output, reading out an initialization program for initializing the system from an mounted IC card to initialize the system according to the above initialization program that was read out; and
after the system was initialized, reading out a write program for writing said normal BIOS stored in said IC card into said BIOSROM from the above IC card to write the above normal BIOS into said BIOSROM according to the above write program that was read out.

3 An IC card to be mounted on an information processing apparatus comprising a BIOSROM, said IC card comprising:
an initialization program for initializing a system of the information processing apparatus;
a BIOS for activating said system normally;
a write program for writing said BIOS into said BIOSROM;
after an electric power source of said information processing apparatus was commissioned, when a command for reading out the BIOS stored in said BIOSROM is input from the above information processing apparatus, initialization program output means for outputting said initialization program to the above information processing apparatus;
after said initialization program was output to said information processing apparatus by said initialization program output means, and the system of the above information processing apparatus was initialized, write program output means for outputting a write program for writing said BIOS into said BIOSROM to the above information processing apparatus; and
according to said write program output by said write program output means, BIOS output means for outputting said BIOS to said information processing apparatus.

4 A program for restoring a faulty BIOS, which was stored in a BIOSROM, and was no longer capable of normally activating a system, to a normal BIOS capable of activating it normally, said program causing a computer to execute the methods of:
when an electric power source is commissioned, outputting a command for reading out the BIOS from said BIOSROM;
before said faulty BIOS is read out from said BIOSROM after said command was output, reading out an initialization program for initializing the system from an mounted IC card to initialize the system according to the above initialization program that was read out; and
after the system was initialized, reading out a write program for writing said normal BIOS stored in said IC card into said BIOSROM from the above IC card to write the above normal BIOS into said BIOSROM according to the above write program that was read out.

5 A record medium stored a program, said program for restoring a faulty BIOS, which was stored in a BIOSROM, and was no longer capable of normally activating a system, to a normal BIOS capable of activating it normally, said program causing a computer to execute the methods of:
when an electric power source is commissioned, outputting a command for reading out the BIOS from said BIOSROM;
before said faulty BIOS is read out from said BIOSROM after said command was output, reading out an initialization program for initializing the system from an mounted IC card to initialize the system according to the above initialization program that was read out; and
after the system was initialized, reading out a write program for writing said normal BIOS stored in said IC card into said BIOSROM from the above IC card to write the above normal BIOS into said BIOSROM according to the above write program that was read out.
